(19) United States
(12) Patent Application Publication
(10) Pub. No.: US 2025/0235812 A1
(43) Pub. Date: Jul. 24, 2025

(54) CARBON DIOXIDE RECOVERY DEVICE

(71) Applicant: HONDA MOTOR CO., LTD., Tokyo (JP)

(72) Inventors: Hiroka SHIGI, Saitama (JP); Masanobu TAKAZAWA, Saitama (JP); Subaru MATSUMOTO, Saitama (JP); Toshiyuki INABA, Saitama (JP); Masayuki SADAKIYO, Saitama (JP)

(21) Appl. No.: 19/033,493

(22) Filed: Jan. 22, 2025

(30) Foreign Application Priority Data
Jan. 23, 2024 (JP) 2024-008222

(51) Int. Cl. B01D 53/04; B01D 53/62

(52) U.S. Cl. CPC B01D 53/0438; B01D 53/62; B01D 2258/06; B01D 2259/40088

(57) ABSTRACT

A carbon dioxide recovery device having high energy efficiency is provided which can suppress the energy required in temperature rise of a sorbent material in a desorption process. The carbon dioxide recovery device includes: a plurality of modules, each one including a sorbent material inside thereof, and executing an adsorption process of aspirating gas containing carbon dioxide and adsorbing the carbon dioxide to the sorbent material; and a desorption process of desorbing the carbon dioxide from the sorbent material by heating in a state where a periphery of the sorbent material is reduced pressure; a heat exchanger supplying heat for heating the sorbent material to each of the plurality of modules via a heat transfer medium; and a bypass path connecting a first module being one among the plurality of the modules, with a second module different from said first module, and enables circulation of the heat transfer medium therebetween.

This application is based on and claims the benefit of priority from Japanese Patent Application No. 2024-008222, filed on 23 Jan. 2024, the content of which is incorporated herein by reference.

### BACKGROUND OF THE INVENTION

### Field of the Invention

The present invention relates to a carbon dioxide recovery device.

### Related Art

Conventionally, technology for recovering carbon dioxide from gas which contains carbon dioxide such as atmospheric air has been known. As a document disclosing this type of technology, Japanese Unexamined Patent Application (Translation of PCT Application), Publication No. 2017-528318 can be exemplified. Japanese Unexamined Patent Application (Translation of PCT Application), Publication No. 2017-528318 discloses a method of separating gaseous carbon dioxide from gas mixture by a cyclic adsorption/desorption using an sorbent material which adsorbs gaseous carbon dioxide.
Patent Document 1: Japanese Unexamined Patent Application (Translation of PCT Application), Publication No. 2017-528318

### SUMMARY OF THE INVENTION

However, in a desorption process of desorbing the carbon dioxide adsorbed to the sorbent material from this sorbent material, it is necessary to establish the sorbent material in a high-temperature state. In order to raise the sorbent material from room temperature to a temperature enabling desorption, a great amount of thermal energy from outside becomes necessary. On the other hand, in the adsorption process of adsorbing carbon dioxide to the sorbent material, although heat of adsorption is generated in the sorbent material, this heat of adsorption has not been used.

The present invention has an object of providing a carbon dioxide recovery device having high energy efficiency which can curb the energy required in raising the temperature of the sorbent material in a desorption process.

A first aspect of the present invention relates to a carbon dioxide recovery device (for example, the carbon dioxide recovery device described later) includes: a plurality of modules (for example, the module 11 described later), each one including a sorbent material (for example, the sorbent material 12 described later) inside thereof, and executing an adsorption process of aspirating gas containing carbon dioxide and adsorbing the carbon dioxide to the sorbent material; and a desorption process of desorbing the carbon dioxide from the sorbent material by heating in a state where a periphery of the sorbent material is reduced pressure; a heat exchanger (for example, the heat exchange device 80 described later) that supplies heat for heating the sorbent material to each of the plurality of modules via a heat transfer medium; and a bypass path (for example, the bypass path 31 described later) that connects a first module (for example, the first module 11A described later), which is one among the plurality of the modules, with a second module (for example, the second module 11B described later), which is different from said first module, and enables circulation of the heat transfer medium therebetween.

According to a second aspect of the present invention, in the carbon dioxide recovery device as described in the first aspect, heat supply from the first module to the second module may be performed by the heat transfer medium which conducted cooling of the first module after the desorption process being supplied through the bypass path to the second module undergoing temperature rise in the desorption process.

According to a third aspect of the present invention, the carbon dioxide recovery device as described in the first or second aspect may further include: a hot water tank (for example, the hot water tank 83 described later) that is disposed between the heat exchanger and the module, and stores hot water as the heat transfer medium.

According to a fourth aspect of the present invention, in the carbon dioxide recovery device as described in the third aspect, the carbon dioxide recovery device may raise temperature of the sorbent material by a two-stage heating of heating the sorbent material by performing heat supply from the hot water tank to the second module, after heating the sorbent material by performing heat supply from the first module to the second module via the bypass path.

According to a fifth aspect of the present invention, in the carbon dioxide recovery device as described in the fourth aspect, the carbon dioxide recovery device may perform heat supply from the first module to the second module via the bypass path, when a temperature difference between the sorbent material in the first module undergoing cooling after the desorption process and the sorbent material in the second module which is a temperature rise target in the desorption process is a fixed value or more; and close the bypass path and starts heat supply from the hot water tank, when the temperature difference between the sorbent material in the first module undergoing the cooling and the sorbent material in the second module which is the temperature rise target is less than a fixed value.

According to a sixth aspect of the present invention, the carbon dioxide recovery device as described in the first or second aspect may further include: a fan (for example, the fan 61 described later) that supplies gas to inside of the module; a heat source (for example, the heat exchange device 80 described later) that performs heat supply for heating the sorbent material in the module; and a vacuum pump (for example, the vacuum pump 62 and the carbon dioxide recovery pump 63 described later) that aspires gas inside of the module, in which at least one among the fan, the heat source and the vacuum pump is shared between the plurality of the modules, and a number M of the modules that are connected in a chain manner together by the bypass path is set based on Equation (1) below, when defining a natural number as N and a ratio obtained by dividing an adsorption time of the sorbent material by a desorption time as R:

$$M = N \times ( R + 1 ) . \qquad Equation ( 1 )$$

According to the present invention, it is possible to provide a carbon dioxide recovery device having high energy efficiency which can curb the energy required in raising the temperature of the sorbent material in a desorption process.

### BRIEF DESCRIPTION OF THE DRAWINGS

FIG. 1 is a schematic diagram showing a configuration related to the flow of a liquid in a carbon dioxide recovery device according to an embodiment of the present invention;

FIG. 2 is a schematic diagram showing a configuration related to the flow of gas in a module of the carbon dioxide recovery device according to the present embodiment;

FIG. 3 is a schematic diagram showing a heat supply path in a first stage of sorbent material temperature rise;

FIG. 4 is a schematic diagram showing a heat supply path in a second stage of sorbent material temperature rise;

FIG. 5 is a schematic diagram showing a heat supply path in a third stage of sorbent material temperature rise;

FIG. 6 provides graphs for describing heat transfer between a first module and a second module during sorbent material temperature rise;

FIG. 7 provides graphs for describing heat transfer between the first module and the second module during sorbent material temperature rise in the case of the conventional technology without a bypass path;

FIG. 8 is a flowchart showing an example of the flow of processing in temperature-rise control by the carbon dioxide recovery device of the present embodiment;

FIG. 9 is a schematic diagram showing a relationship between the cycle of repeating the adsorption process and the desorption process and heat transfer between a plurality of modules;

FIG. 10 is a schematic diagram showing the numerals assigned to the modules of the carbon dioxide recovery device according to the present embodiment; and

FIG. 11 is a graph showing heat transfer between sixteen modules in the present embodiment.

### DETAILED DESCRIPTION OF THE INVENTION

Hereinafter, embodiments of the present invention will be described by referencing the drawings.

### Overall Configuration

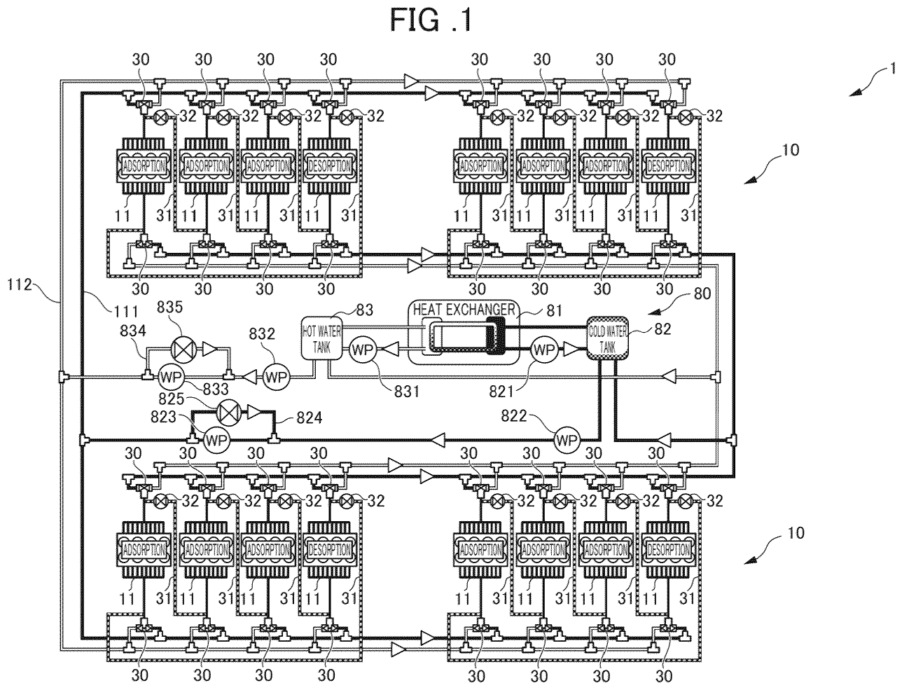

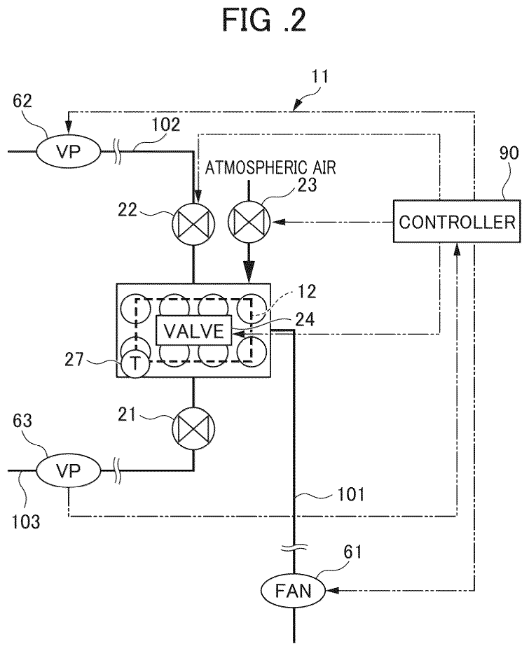

FIG. 1 is a schematic diagram showing a configuration related to a flow of a liquid in a carbon dioxide recovery device 1 according to an embodiment of the present invention. FIG. 2 is a schematic diagram showing a configuration related to a flow of gas in a module 11 of the carbon dioxide recovery device 1 according to the present embodiment. It should be noted that illustrations of configurations related to the flow of gas in the carbon dioxide recovery device 1 in FIG. 1 are abbreviated.

The carbon dioxide recovery device 1 of the present embodiment, for example, is applied to direct air recovery technology (DAC: Direct Air Capture) which recovers the carbon dioxide in the atmosphere, in order to decrease the carbon dioxide concentration in the atmosphere. The carbon dioxide recovered by the carbon dioxide recovery device 1 is stored in the ground, and is reused as a fuel or raw material.

As shown in FIGS. 1 and 2, the carbon dioxide recovery device 1 according to the present embodiment includes a module unit 10, a fan 61, a vacuum pump 62, a carbon dioxide recovery pump 63, and a heat exchange device 80.

The module unit 10 is configured by a plurality of the modules 11 which adsorb carbon dioxide being arranged in a line. In the present embodiment, a total number of sixteen of the modules 11 are arranged by a pair of left and right module units 10.

As shown in FIG. 2, the module 11 is a carbon dioxide recovery module which includes a sorbent material 12, a first valve 21, a second valve 22, a third valve 23, a fourth valve 24, and a temperature sensor 27.

The sorbent material 12 is arranged inside of the module 11 in order to adsorb carbon dioxide. The sorbent material 12 is a member in particle form, and has a property of adsorbing carbon dioxide in a low-temperature state (for example, range of −30° C. to 50° C.), and desorbing (releasing) carbon dioxide in a state of high temperature (for example, range of 50° C. to 110° C.) and low concentration of carbon dioxide in the surroundings. As such a sorbent material 12, for example, a carbon dioxide sorbent material of a solid amine configured by supporting an amine on a porous material such as silica, or the like can be exemplified.

The first valve 21 is a switching value arranged at a connection of the module 11 with a carbon dioxide line 103 recovering the carbon dioxide. A carbon dioxide recovery pump 63 is arranged in the carbon dioxide line 103. The second valve 22 is a switching valve arranged at a connection of the module 11 with the vacuum line 102 in which the vacuum pump 62 is arranged. The third valve 23 is a switching value arranged at an inlet which suctions atmospheric air, etc. into the module 11. The fourth valve 24 is a switching valve arranged at a connection of the module 11 with an adsorption line 101. A fan 61 is arranged in the adsorption line 101.

The first valve 21, the second valve 22, the third valve 23 and the fourth valve 24 are all controlled to open and close by the controller 90. The first valve 21, the second valve 22, the third valve 23 and the fourth valve 24, for example, are configured by butterfly valves which are normal open. The temperature sensor 27 measures the temperature of the sorbent material 12. The measurement information of the temperature sensor 27 is sent to the controller 90.

The adsorption line 101 is branched to connect to each of the respective modules 11. The fan 61 is arranged at portion of the adsorption line 101 at which a branching portion merges. The fan 61 produces flow of gas from “intake” to “exhaust” relative to the module 11 through the adsorption line 101 by being driven. The atmospheric air is thereby supplied into the module 11.

The vacuum line 102 is branched to connect to each of the respective modules 11. The vacuum pump 62 is arranged at a portion of the vacuum line 102 at which the branched portions merge together. The vacuum pump 62 aspirates gas inside of the module 11 through the vacuum line 102 by way of being driven to make the inside of the module 11 a vacuum state or bring it close to a vacuum state.

The carbon dioxide line 103 is branched to connect to each of the respective modules 11. At a portion of the carbon dioxide line 103 at which the branched portion merges, the carbon dioxide recovery pump 63 is arranged. The carbon dioxide recovery pump 63 causes the suction force to act on carbon dioxide flowing in the carbon dioxide line 103, and stores the recovered carbon dioxide in a tank (not shown) which stores carbon dioxide.

Referring back to FIG. 1, the heat exchange device 80 will be described. The heat exchange device 80, upon each module 11 of the module unit 10 performing the desorption process, supplies thermal energy for heating inside this module 11 up to a predetermined temperature. In addition, the heat exchange device 80 recovers thermal energy which is unneeded upon each module 11 performing the adsorption process.

The heat exchange device 80 of the present embodiment includes: a heat exchanger 81, a cold water tank 82, a cold water line 111, a hot water tank 83, a hot water line 112, three-way valves 30, a bypass path 31 and a bypass valve 32.

The heat exchanger 81 performs heat exchange between a heat transfer medium flowing in the cold water line 111, and a heat transfer medium flowing in the hot water line 112. The heat exchanger 81, for example, is a heat pipe. The heat transfer medium, for example, is a liquid such as water. The heat transfer medium flowing in the cold water line 111 is cooled by the heat transfer occurring in the heat exchanger 81, and the heat transfer medium flowing in the hot water line 112 is heated.

The cold water tank 82 stores the heat transfer medium flowing in the cold water line 111. The heat transfer medium flowing in the cold water line 111 is stored in the cold water tank 82, and then is sent to the heat exchanger 81. In addition, the heat transfer medium cooled by the heat exchanger 81 is returned to the cold water tank 82, and then is sent to each module 11 through the cold water line 111. A heat-exchanger circulation water pump 821 is arranged between the cold water tank 82 and the heat exchanger 81 in the cold water line 111. By driving heat-exchanger circulation water pump 821, the heat transfer medium flowing in the cold water line 111 circulates between the cold water tank 82 and the heat exchanger 81.

The cold water line 111 is branched to connect to the upstream side and the downstream side of each of the respective modules 11, and connects the cold water tank 82 with each of the modules 11. In addition, a first cold-water circulation water pump 822 and a second cold-water circulation water pump 823 are arranged between the cold water tank 82 and each module 11 in the cold water line 111. In addition, a circulation line 824 which returns from the downstream side to the upstream side of the second cold-water circulation water pump 823 is arranged in the cold water line 111. A circulation valve 825 is arranged in this circulation line 824.

The hot water tank 83 stores the heat transfer medium flowing in the hot water line 112. The heat transfer medium flowing in the hot water line 112 is stored in the hot water tank 83, and then sent to the heat exchanger 81. In addition, the heat transfer medium heated by the heat exchanger 81 is returned to the hot water tank 83, and then sent to each module 11 through the hot water line 112. A heat-exchanger circulation water pump 831 is arranged between the hot water tank 83 and the heat exchanger 81 in the hot water line 112. By driving the heat-exchanger circulation water pump 831, the heat transfer medium flowing in the hot water line 112 circulates between the hot water tank 83 and the heat exchanger 81.

The hot water line 112 is branched to connect to the upstream side and the downstream side of each of the respective modules 11, and connects the hot water tank 83 and each module 11. In addition, a first hot-water circulation water pump 832 and a second hot-water circulation water pump 833 are arranged between the hot water tank 83 and each module 11 in the hot water line 112. In addition, a circulation line 834 which returns from the downstream side to the upstream side of the second hot-water circulation water pump 833 is arranged in the hot water line 112. A circulation valve 835 is arranged in this circulation line 834.

The three-way valve 30 is connected to the cold water line 111, the hot water line 112 and the module 11. Three-way valves 30 are respectively arranged at the upstream side and the downstream side of the module 11. The three-way valve 30 is configured to be switchable between a cold-water connection state connecting the cold water line 111 and the module 11, a hot-water connection state connecting the hot water line 112 and the module 11, and a closed state blocking connection between the cold water line 111 and the hot water line 112 with the module 11.

The flow path switching of the three-way valve 30 is controlled by the controller 90. The heat transfer medium is introduced to the module 11 through the three-way valve 30 arranged on the upstream side, and the heat transfer medium is returned to the heat exchanger 81 side through the three-way valve 30 arranged on the downstream side.

The bypass path 31 is a flow path enabling the movement of the heat transfer medium between modules 11. The bypass path 31 connects between two modules 11. The modules 11 connected by the bypass path 31 may be adjacent modules, or may be modules 11 at non-adjacent separated positions. Details of the connection structure of this bypass path 31 are described later.

The bypass valve 32 is arranged in the bypass path 31. A bypass valve 32 is arranged in each of a plurality of bypass paths 31. The bypass valve 32 is controlled to open and close by the controller 90.

Next, the controller 90 will be described. The controller 90 controls the operation of each part of the carbon dioxide recovery device 1. The controller 90 controls operations such as driving and stopping of devices used in the adsorption and desorption of carbon dioxide. The controller 90 performs switching control of the first valve 21, the second valve 22, the third valve 23 and the fourth valve 24 provided to each module 11, and switching control of the respective bypass valves 32. In addition, the controller 90 performs driving control of the fan 61, the vacuum pump 62, the carbon dioxide recovery pump 63, the heat-exchanger circulation water pump 821, the first cold-water circulation water pump 822, the second cold-water circulation water pump 823, the heat-exchanger circulation water pump 831, the first hot-water circulation water pump 832 and the second hot-water circulation water pump 833, and switching control of the circulation valve 825 and the circulation valve 835.

The controller 90, for example, is a computer that has a CPU (Central Processing Unit), ROM (Read Only Memory), RAM (Random Access Memory), etc. The controller 90 may be configured as one unit, or may be configured by several units.

### <Recovery of Carbon Dioxide>

Next, control for recovering carbon dioxide by the controller 90 will be described. The carbon dioxide recovery device 1 removes and recovers carbon dioxide from the air by alternately performing an adsorption process of adsorbing carbon dioxide in gas aspirated such as atmospheric air to the sorbent material 12 in the module 11, and a desorption process of desorbing the carbon dioxide adsorbed to the sorbent material 12, and then compresses the desorbed carbon dioxide and stores in a tank (not shown). In the present embodiment, the adsorption process and the desorption process are performed with a time of adsorption process: a time of desorption process=3:1.

The adsorption process is a process of adsorbing carbon dioxide to the sorbent material 12 inside the module 11. In the adsorption process, the third valve 23 and the fourth valve 24 of the module 11 are opened, and the first valve 21 and the second valve 22 are closed. The fan 61 is driven, whereby a flow of gas from upstream to downstream is generated, and the gas containing carbon dioxide (for example, atmospheric air) is aspirated through the third valve 23. The aspirated gas passes through the sorbent material 12 inside the module 11. At this time, the inside of the module 11 is room temperature (25° C.), and the carbon dioxide in the gas is adsorbed to the sorbent material 12. Gas other than carbon dioxide, for example, nitrogen, oxygen, etc., are exhausted to outside of the carbon dioxide recovery device 1 through the fourth valve 24 and the adsorption line 101.

The desorption process is a process of desorbing the carbon dioxide on the sorbent material 12 within the module 11. In the desorption process, the first valve 21, the third valve 23 and the fourth valve 24 of the module 11 are closed, and the second valve 22 is opened. The vacuum pump 62 runs to aspirate inside of the module 11, and reduces the pressure to a vacuum state or brings it close to a vacuum state. Simultaneously, the heat transfer medium serving as a heat source flows with the module 11 to supply thermal energy by way of the heat exchange device 80, whereby the sorbent material 12 of the module 11 is raised in temperature. Temperature-rise control by this heat exchange device 80 is described later.

By temperature-rise control of the sorbent material 12, the sorbent material 12 is also heated to a predetermined temperature (for example, 80° C.) adequate for the desorption process, and the carbon dioxide adsorbed to the sorbent material 12 is desorbed. Next, the second valve 22, the third valve 23 and the fourth valve 24 are closed, the first valve 21 is opened, and the carbon dioxide recovery pump 63 is driven, whereby the carbon dioxide desorbed through the carbon dioxide line 103 is stored in a tank (not shown). In the present embodiment, the respective processes are controlled so that, among the sixteen of the modules 11, twelve of them execute the adsorption process, and the remaining four perform the desorption process.

### <Temperature-Rise Control of Sorbent Material>

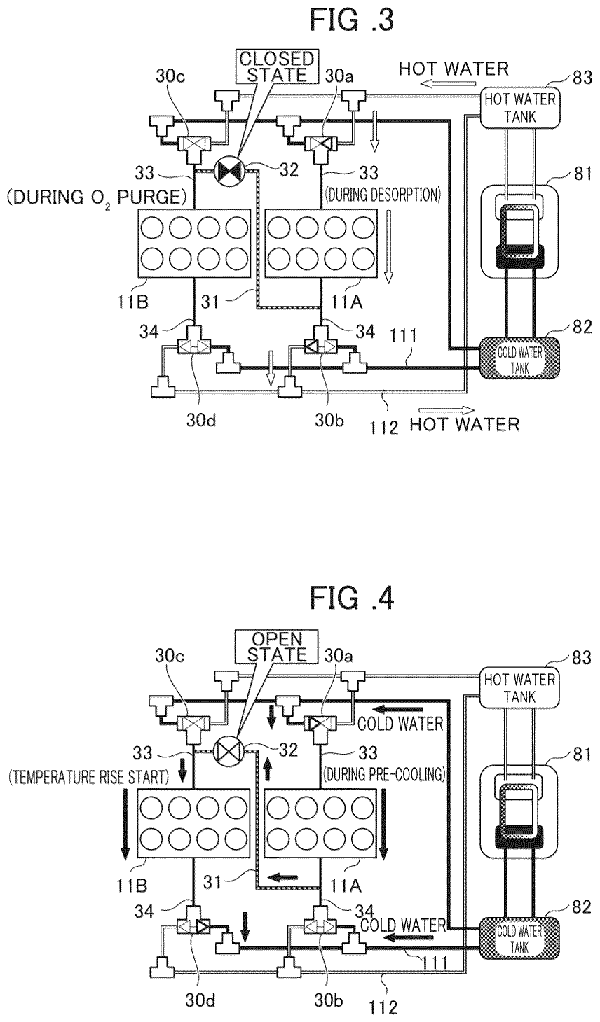

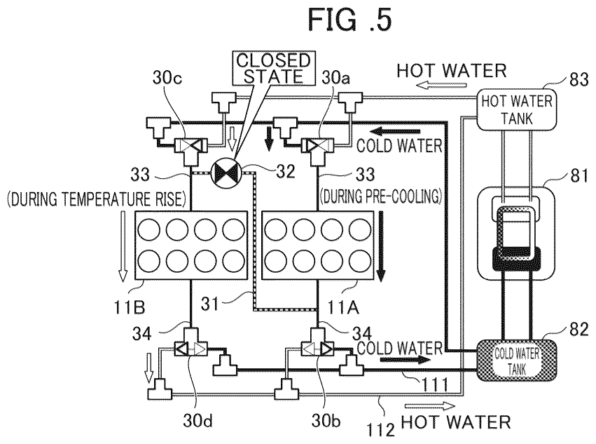

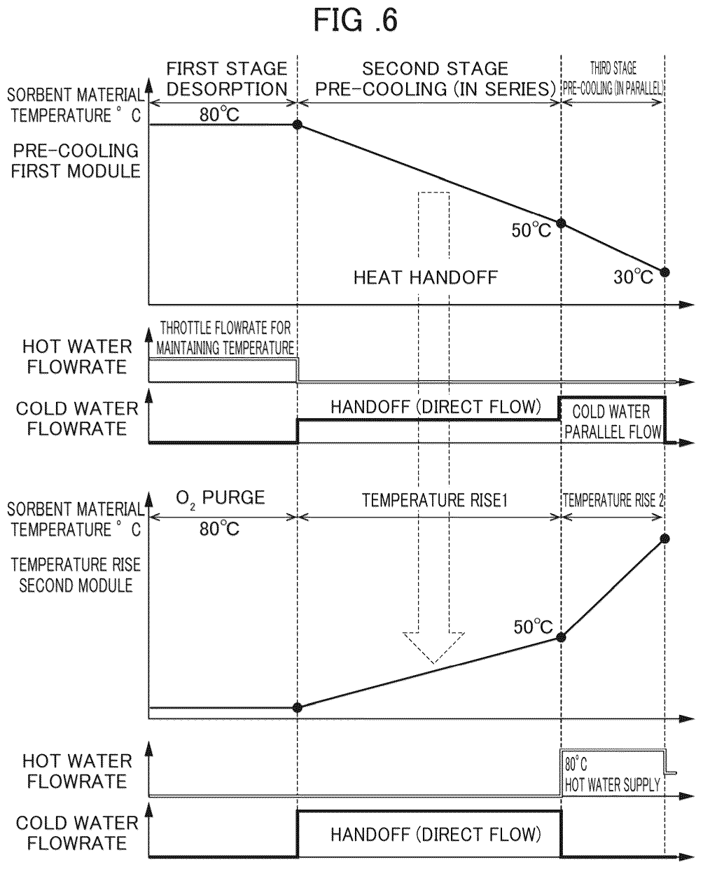

Temperature-rise control of the sorbent material 12 will be described. FIG. 3 is a schematic diagram showing a heat supply path in a first stage of temperature rise of the sorbent material 12, FIG. 4 is a schematic diagram showing a heat supply path in a second stage of temperature rise of the sorbent material 12, and FIG. 5 is a schematic diagram showing a heat supply path in a third stage of temperature rise of the sorbent material 12. FIG. 6 provides graphs for describing heat transfer of a first module 11A and a second module 11B during temperature rise of the sorbent material 12. It should be noted that illustration of the remaining modules 11 is omitted in FIGS. 3 to 6.

In the following description, the first module 11A and the second module 11B connected by the bypass path 31 will be explained as examples among the plurality of modules 11. It should be noted that there are cases where shared configurations which do not distinguish between the first module 11A and the second module 11B are noted by omitting the alphabetic character as module 11.

First, the structure providing the heat transfer medium to the first module 11A and the second module 11B will be described. As shown in FIGS. 3 to 5, each of the first module 11A and the second module 11B includes an inlet-side flow path 33 connected to an inlet to which the heat transfer medium flows, and an outlet-side flow path 34 connected to an outlet from which the heat transfer medium exits.

The bypass path 31 is connected to the outlet-side flow path 34 of the first module 11A and connected to the inlet-side flow path 33 of the second module 11B. In addition, a three-way valve 30 is arranged at an upstream-side end of the inlet-side flow path 33, and a three-way valve 30 is also arranged at a downstream-side end of the outlet-side flow path 34.

The three-way valve 30 arranged at the upstream-side end of the inlet-side flow path 33 of the first module 11A is defined as an inlet three-way valve 30a, and the three-way valve 30 arranged at the downstream-side end of the outlet-side flow path 34 thereof is defined as an outlet three-way valve 30b. In addition, a three-way valve 30 arranged on an upstream-side end of the inlet-side flow path 33 of the second module 11B is defined as an inlet three-way valve 30c, and a three-way valve 30 arranged on a downstream-side end of the outlet-side flow path 34 thereof is defined as an outlet three-way valve 30d.

A first stage of temperature-rise control will be described. As shown in FIG. 3, a desorption process is executed by the first module 11A in the first stage. In the first stage, the controller 90 controls the inlet three-way valve 30a to connect the hot water line 112 and the inlet-side flow path 33, and controls the outlet three-way valve 30b to connect the outlet-side flow path 34 and the hot water line 112. In addition, the controller 90 blocks the outlet-side flow path 34 of the first module 11A and the inlet-side flow path 33 of the second module 11B, by controlling the bypass valve 32 arranged in the bypass path 31 to a closed state.

As shown in FIG. 6, in the desorption process, the heat transfer medium in the hot water line 112 is introduced to the first module 11A, and the temperature of the sorbent material 12 in the first module 11A reaches 80° C. The flowrate of the heat transfer medium passing through the hot water line 112 to the first module 11A is throttled so that the temperature of the sorbent material 12 is maintained at 80° C. It should be noted that the temperature of the sorbent material 12 in the second module 11B is room temperature at 30° C. or less.

With the second module 11B in the first stage, the controller 90 controls the inlet three-way valve 30c and the outlet three-way valve 30d to block the second module 11B from both the cold water line 111 and the hot water line 112. In this state, the controller 90 controls the first valve 21, the third valve 23 and the fourth valve 24 of the module 11 to the closed state, and controls the second valve 22 thereof to the open state, and drives the vacuum pump 62. The operation of purging O₂ inside of the second module is thereby executed by suctioning of the vacuum pump 62 on the second module 11B.

The second stage of temperature-rise control will be described. As shown in FIG. 4, in the first module 11A in the second stage, the desorption process ends, and pre-cooling is started. In the second stage, the controller 90 controls the inlet three-way valve 30a to connect the cold water line 111 and the inlet-side flow path 33, and controls the outlet three-way valve 30b to block the first module 11A from both the cold water line 111 and the hot water line 112. In addition, the controller 90 connects the outlet-side flow path 34 of the first module 11A and the inlet-side flow path 33 of the second module 11B, by controlling the bypass valve 32 to the open state.

As shown in FIG. 6, the heat transfer medium in the cold water line 111 is introduced to the first module 11A, and the temperature of the sorbent material 12 in the first module 11A is gradually cooled from 80° C. to 50° C. The heat transfer medium having flowed out from the first module 11A to the outlet-side flow path 34 is introduced to the inlet-side flow path 33 of the second module 11B through the bypass path 31, since the outlet three-way valve 30b is closed. The heat transfer medium passing through the bypass path 31 cools the sorbent material 12 while passing through the first module 11A, and thus is heated by heat transfer, and reaches a higher temperature than prior to introduction to the first module 11A.

With the second module 11B in the second stage, the controller 90 controls the inlet three-way valve 30c to block the inlet-side flow path 33 of the second module 11b from both the cold water line 111 and the hot water line 112, and controls the outlet three-way valve 30d to connect the outlet-side flow path 34 of the second module 11B and the cold water line 111.

As shown in FIG. 6, the heat transfer medium passing through the bypass path 31 and the inlet-side flow path 33 and heated by the first module 11A is introduced to the second module 11B, and the temperature of the sorbent material 12 in the second module 11B gradually rises from room temperature to 50° C. In this way, in the second stage, a handoff of heat from the first module 11A to the second module 11B is performed.

A third stage of temperature-rise control will be described. As shown in FIG. 5, with the first module 11A in the third stage, pre-cooling is continued. In the third stage, the controller 90 controls the outlet three-way valve 30b to connect the outlet-side flow path 34 and the cold water line 111, while maintaining the connection between the cold water line 111 and the inlet-side flow path 33 by the inlet three-way valve 30a. In addition, the controller 90 closes the outlet-side flow path 34 of the first module 11A and the inlet-side flow path 33 of the second module 11B, by controlling the bypass valve 32 to the closed state.

As shown in FIG. 6, introduction of the heat transfer medium in the cold water line 111 to the first module 11A is continued, and the temperature of the sorbent material 12 in the first module 11A is gradually cooled from 50° C. to 30° C. The heat transfer medium having flowing out from the first module 11A to the outlet-side flow path 34 is returned to the cold water line 111 through the outlet three-way valve 30b.

With the second module 11B in the third stage, the controller 90 controls the inlet three-way valve 30c to connect the inlet-side flow path 33 and the hot water line 112, and controls the outlet three-way valve 30d to connect the outlet-side flow path 34 and the hot water line 112.

As shown in FIG. 6, the heat transfer medium at 80° C. in the hot water line 112 is introduced to the second module 11B, and the temperature of the sorbent material 12 in the second module 11B is gradually raised in temperature from 50° C. to 80° C.

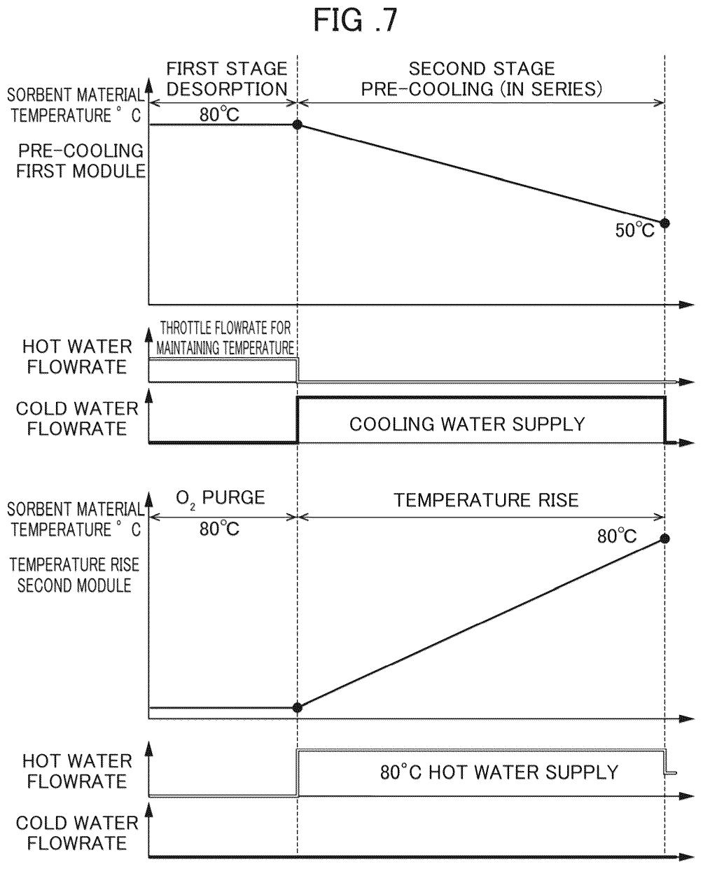

Herein, the differences between the carbon dioxide recovery device 1 according to the present embodiment and a carbon dioxide recovery device of the conventional technology will be described while referencing FIG. 7. FIG. 7 is a graph for describing heat transfer of the first module and the second module during temperature rise of the sorbent material in the case of the conventional technology without the bypass path 31.

As shown in FIG. 7, in the case of omitting the bypass path 31 in the configurations of FIGS. 3 to 5, since heat transfer from the first module 11A to the second module 11B is not carried out, the temperature-rise control is performed independently in the first module 11A and the second module 11B. Since the heat transfer medium receiving heat from the first module 11A during cooling is returned to the cold water tank 82 via the cold water line 111, without being used by the second module 11B, the received heat during cooling is also equalized within the cold water tank 82. For this reason, it is necessary to supply hot water from a stage at room temperature to the sorbent material 12 in the second module. In this point, according to the configuration of the present embodiment, since the sorbent material 12 in the second module 11B is heated in advance in the second stage, it is sufficient so long as raising the temperature from 50° C. to 80° C. in the third stage, and thus the supplied amount of hot water can be made less compared to a case without the bypass path 31.

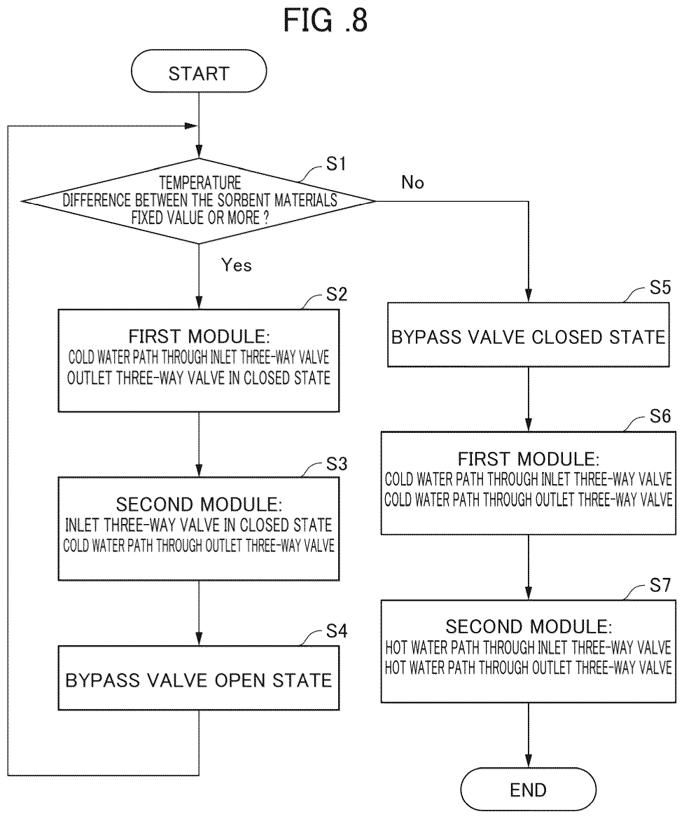

Next, the switching timing of the supply path of heat transfer medium in temperature-rise control will be described while referencing FIG. 8. FIG. 8 is a flowchart showing an example of the flow of processing in temperature-rise control by the carbon dioxide recovery device according to the present embodiment.

In Step S1, the controller 90 determines whether a temperature difference ΔT between the sorbent material 12 in the first module 11A and the sorbent material 12 in the second module 11B is a fixed value or more. In the present embodiment, the controller 90 acquires the measurement information of the temperature sensor 27 of the first module 11A, and acquires measurement information of the temperature sensor 27 of the second module 11B, and then calculates the temperature difference. The controller 90 determines whether the calculated temperature difference is equal to the temperature difference ΔT set in advance or more.

In the case of the temperature difference ΔT between the sorbent material 12 in the first module 11A and the sorbent material 12 in the second module 11B being a fixed value or more, the controller 90 advances the processing to Step S2 (Step S1: Yes). In the case of the temperature difference ΔT between the sorbent material 12 in the first module 11A and the sorbent material 12 in the second module 11B being less than the fixed value, the controller 90 advances the processing to Step S5 (Step S1: No).

It should be noted that the processing of Step S2 to S4 corresponds to the second stage shown in FIG. 4, and the processing of Steps S5 to S7 corresponds to the third stage shown in FIG. 5.
In Step S2, the controller 90 controls the inlet three-way valve 30a of the first module 11A to connect the cold water line 111 and the inlet-side flow path 33, and controls the outlet three-way valve 30b to block the first module 11A from both the cold water line 111 and the hot water line 112.
In Step S3, the controller 90 controls the inlet three-way valve 30c to block the inlet-side flow path 33 of the second module 11B from both the cold water line 111 and the hot water line 112, and controls the outlet three-way valve 30d to connect the outlet-side flow path 34 of the second module 11B and the cold water line 111.
In Step S4, the controller 90 controls the bypass valve 32 to the open state, thereby connecting the outlet-side flow path 34 of the first module 11A and the inlet-side flow path 33 of the second module 11B. After the processing of Step S4, the processing returns to Step S1, and the processing of Step S1 and after is executed.
In the case of the temperature difference being less than ΔT, in Step S5, the controller 90 controls the bypass valve 32 to the closed state, thereby blocking the outlet-side flow path 34 of the first module 11A and the inlet-side flow path 33 of the second module 11B.
In Step S6, the controller 90 controls the inlet three-way valve 30a to connect the inlet-side flow path 33 of the first module 11A and the cold water line 111, and controls the outlet three-way valve 30b to connect the outlet-side flow path 34 of the first module 11A and the cold water line 111.
In Step S7, the controller 90 controls the inlet three-way valve 30c to connect the inlet-side flow path 33 of the second module 11B and the hot water line 112, and controls the outlet three-way valve 30d to connect the outlet-side flow path 34 of the second module 11B and the hot water line 112. Temperature-rise control of the second module 11B thereby ends, and transitions to the desorption process.

It should be noted that, for convenience of explanation, the flowchart of FIG. 8 is illustrated by dividing into Step S2, Step S3 and Step S4; however, Step S2, Step S3 and Step S4 may be performed simultaneously. Step S5, Step S6 and Step S7 may similarly also be performed simultaneously. In this way, the flowchart of FIG. 8 is an example, and the sequence and contents of processing can be modified as appropriate.

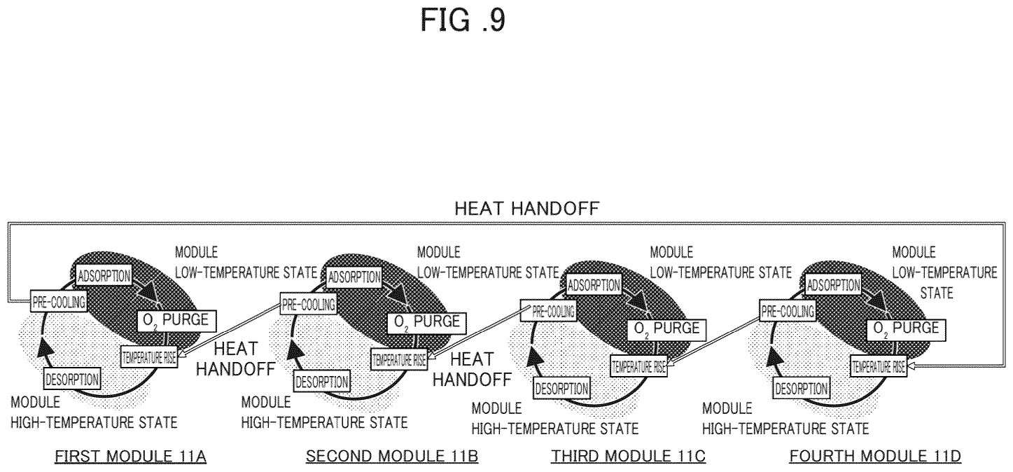

The heat transfer described above is performed between the modules 11 connected via the bypass path 31. FIG. 9 is a schematic diagram showing the relationship between a cycle of repeating the adsorption process and the desorption process, and heat transfer between a plurality of the modules 11. As shown in FIG. 9, in each of the modules 11, a cycle of desorption, pre-cooling, adsorption, Oz purge, and temperature rise is executed.

The first module 11A and the second module 11B are connected by the bypass path 31. The second module 11B and the third module 11C are also connected by a different bypass path 31. The third module 11C and the fourth module 11D are also connected by a different bypass path 31. Furthermore, the fourth module 11D and the first module 11A are also connected by a different bypass path 31. In the present embodiment, the four modules 11 of the first module 11A, the second module 11B, the third module 11C and the fourth module 11d are established as one set, and a circuit performing handoff of heat is configured by this one set.

When the first module 11A advances to the cycle of temperature rise, and the second module 11B advances to the cycle of pre-cooling, heat transfers from the second module 11B which is in pre-cooling to the first module 11A which is in temperature rise. When the second module 11B advances to the cycle of temperature rise, and the third module 11C advances to the cycle of pre-cooling, heat transfers from the third module 11C which is in pre-cooling to the second module 11B which is in temperature rise. When the third module 11C advances to the cycle of temperature rise, and the fourth module 11D advances to the cycle of pre-cooling, heat transfers from the fourth module 11D which is in pre-cooling to the third module 11C which is in temperature rise. When the fourth module 11D progresses in the cycle of temperature rise, and the first module 11A advances in the cycle of pre-cooling, heat transfers from the first module 11A during pre-cooling to the fourth module 11D during temperature rise. In the present embodiment, such heat transfer is performed with each of sixteen modules 11.

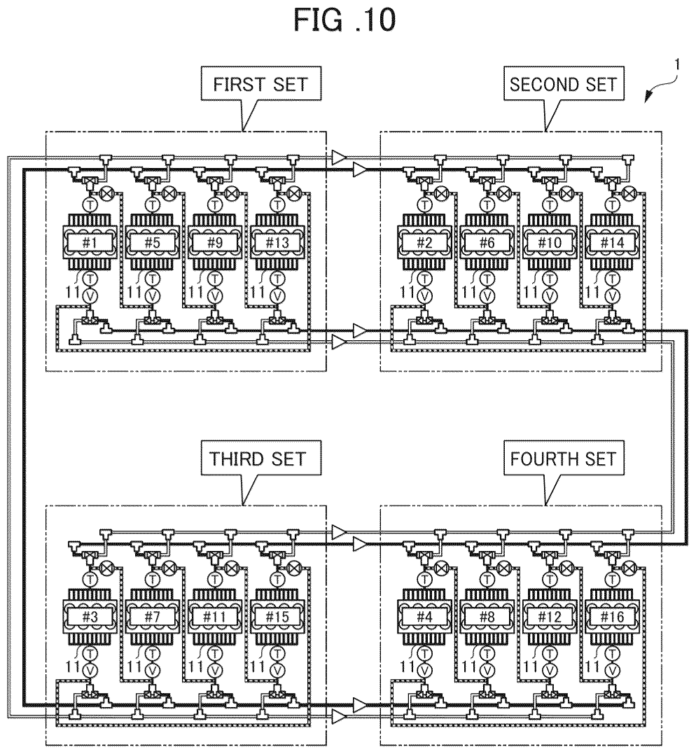

FIG. 10 is a schematic diagram showing the numerals assigned to the modules 11 of the carbon dioxide recovery device 1 according to the present embodiment. In FIG. 10, the numerals for distinguishing the modules 11 are indicated by # and a numeric character. In the example shown in FIG. 10, the module 11 of #1, the module 11 of #5, the module 11 of #9 and the module 11 of #13 are a first set. The module 11 of #2, the module 11 of #6, the module 11 of #10 and the module 11 of #14 are a second set. The module 11 of #3, the module 11 of #7, the module 11 of #11 and the module 11 of #15 are a third set. The module 11 of #4, the module 11 of #8, the module 11 of #12 and the module 11 of #16 are a fourth set. In all of the first set, the second set, the third set and the fourth set, the four modules 11 are respectively connected in a chain manner together as shown in FIG. 10 by the bypass paths 31. Heat transfer between the modules 11 is carried out as one set unit.

In addition, in the present embodiment, the respective processing for executing the adsorption process and the desorption process is executed to be shifted between the plurality of the modules 11 so as not to be performed at the same timing. It is thereby possible to reliably avoid the occurrence of a situation where pieces of equipment (fan 61, heat exchange device 80 and vacuum pump 62, carbon dioxide recovery pump 63) simultaneously operate, and the output instantaneously rises. In addition, the time calculated by dividing the sum of the adsorption time and desorption time by the number M of modules 11 is set as the time difference of the operation timing between the modules 11. The operating time and output of each piece of equipment in the running time can be set more evenly, and the operation for realizing the respective processing of the adsorption process and the desorption process can be made more constant, whereby the energy efficiency can be improved. Furthermore, in the viewpoint of equalizing the load, the number of modules 11 is preferably ten or more.

### <Setting Method of Module Number and One Set>

In the present embodiment, the number of the modules 11 constituting one set is set so as to correspond to the following Equation (1). In Equation (1), M indicates the number of the modules 11 constituting one set, N indicates a natural number, and R indicates a ratio of the adsorption time and the desorption time (adsorption time/desorption time).

$$M = N \times ( R + 1 ) \qquad Equation ( 1 )$$

Herein, it is set as adsorption time: desorption time=3:1. In this case, R, which is the ratio of adsorption time to desorption time (adsorption time/desorption time), is 3. Therefore, the proper number of the modules 11 is 4 (N=1), 8 (N=2), 12 (N=3), 16 (N=4) . . . . The module number constituting a set to which the bypass path 31 is connected is set based on the proper number of the modules 11 based on Equation (1). In the case of R being 3, the number of modules 11 that make one set is four. A case of the overall number of modules 11 being 8 makes two sets, and a case of the overall number of modules 11 being 12 makes three sets. A case of the overall number of modules 11 being 16 makes four sets, as in the above embodiment.

It should be noted that, according to Equation (1), there is a possibility of M being a numerical value accompanied by decimal places; however, the value of N is set so that the module number actually set is a natural number. For example, in the case of R=2.5, the natural number is an even number of 2, 4, 6 . . . , and the proper number of modules 11 is 7 (N=2), 14 (N=4), and 21 (N=6). In addition, in the case of R=3.5, the natural number is an even number of 2, 4, 6 . . . , and the proper number of modules 11 is 9 (N=2), 18 (N=4), and 27 (N=6). In other words, N is set so that the number of modules 11 becomes a natural number. In this way, there are multiple optimum numbers of modules 11 selected according to R, which is the ratio of adsorption/desorption time.

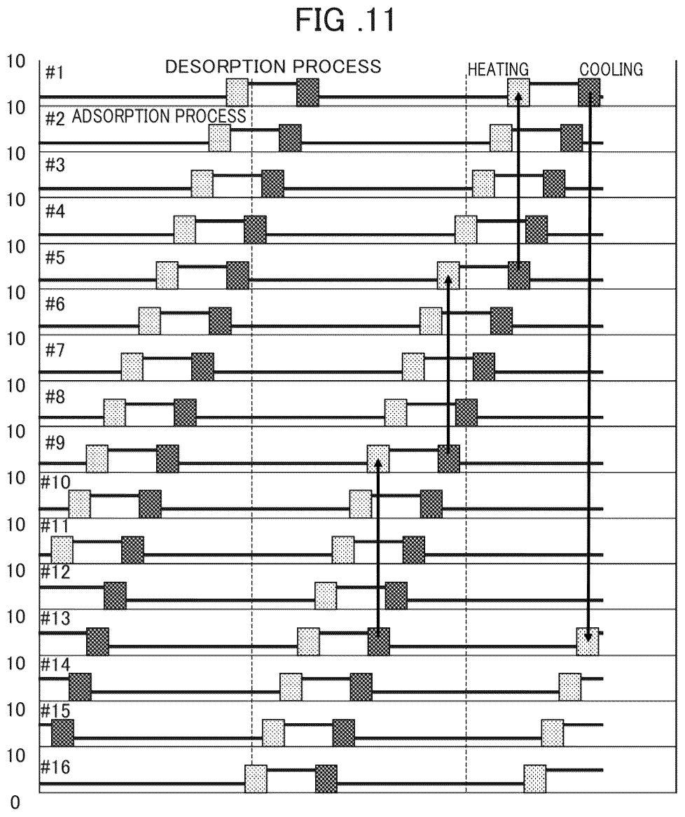

FIG. 11 is a graph showing the heat transfer between sixteen modules according to the present embodiment. In FIG. 11, the heat transfer in the adsorption process and the desorption process for every numeral of the module 11 is shown. The vertical axis is the proportion of heat transfer. As shown in FIG. 11, the number of modules 11 is set based on Equation (1), and the number of modules 11 in one set is set to the smallest proper number of modules 11 based on Equation (1), whereby it becomes possible to minimize the thermal energy required by the carbon dioxide recovery device 1 as a whole.

As described above, the carbon dioxide recovery device 1 according to the present embodiment includes: a plurality of the modules 11, each including the sorbent material 12 inside thereof, and executing an adsorption process of aspirating gas containing carbon dioxide and adsorbing the carbon dioxide to the sorbent material 12; and a desorption process of desorbing the carbon dioxide from the sorbent material 12 by heating in a state where a periphery of the sorbent material 12 is reduced pressure; the heat exchange device 80 that supplies heat for heating the sorbent material 12 via a heat transfer medium to each of the plurality of modules 11; and the bypass path 31 that connects the first module 11A, which is one among the plurality of the modules 11, with the second module 11B which is different from the first module 11A and enables circulation of the heat transfer medium.

It is thereby possible to perform waste heat recovery between the first module 11A and the second module 11B. Transfer of the thermal energy with good efficiency between the first module 11A and the second module 11B is possible, and thus the electrical energy required for heating the heat transfer medium such as the hot water can be reduced.

In addition, in the present embodiment, the heat transfer medium carrying out cooling of the first module 11A after the desorption process is supplied through the bypass path 31 to the second module 11B undergoing temperature rise in the desorption process, whereby the heat supply from the first module 11A to the second module 11B is performed. The heat received by the heat transfer medium during cooling of the first module 11A can thereby be transmitted to the second module 11B directly without passing through the cold water line 111, and thus the energy efficiency can be further enhanced.

In addition, the carbon dioxide recovery device 1 according to the present embodiment further includes a hot water tank 83 which is arranged between the heat exchange device 80 and the module 11, and stores the hot water as a heat transfer medium. It is thereby possible to efficiently and reliably raise the temperature of the sorbent material 12, which is the temperature rise target, by way of the two heat supplies of the heat supply from the first module 11A to the second module 11B through the bypass path 31, and the heat supply by the hot water from the hot water tank 83.

In addition, in the present embodiment, temperature rise of the sorbent material 12 is carried out by the two-stage heating which heats the sorbent material 12 by performing heat supply from the hot water tank 83 on the second module 11B, after heating the sorbent material 12 by carrying out heat supply from the first module 11A to the second module 11B via the bypass path 31. Since pre-heating of the second module 11B is thereby performed using the heat of the first module 11A in advance, the hot water amount required to raise the temperature of the sorbent material 12 in the second module 11B to a predetermined temperature (for example, 80° C.) can be reduced, and thus the energy cost can be further reduced.

In addition, in the present embodiment, heat supply from the first module 11A to the second module 11B via the bypass path 31 is carried out in the case of the temperature difference between the sorbent material 12 in the first module 11A undergoing cooling after the desorption process and the sorbent material 12 in the second module 11B which is the temperature rise target in the desorption process, and when the temperature difference between the sorbent material 12 in the first module 11A undergoing cooling and the sorbent material 12 in the second module 11B which is the temperature rise target becomes less than a fixed value, the bypass path 31 is closed and heat supply from the hot water tank 83 is started. However, the heat transfer from the first module 11A to the second module 11B is not substantially carried out if there is no longer a temperature difference between the first module 11A and the second module 11B, and thus it is preferable to quickly switch to heat supply from the hot water tank 83. In this point, according to the configuration of the present embodiment, switching from heat supply from the first module 11A to the second module 11B to heat supply from the hot water tank 83 is automatically carried out at the appropriate timing. It is possible to avoid the occurrence of a situation where the timing of switching to heat supply from the hot water tank 83 is delayed and the time until the desorption process completes becomes longer, and thus more efficient carbon dioxide recovery can be realized.

In addition, in the present embodiment, the carbon dioxide recovery device 1 further includes: the fan 61 supplying gas to inside of the module 11, the heat exchange device 80 as a heat source that performs heat supply for heating the sorbent material 12 of the module 11, and the vacuum pump 62 and the carbon dioxide recovery pump 63 suctioning the gas inside of the module 11, in which at least one of the fan 61, the heat exchange device 80 and vacuum pump 62 and the carbon dioxide recovery pump 63 is shared between a plurality of the modules 11, and the number M of the modules 11 connected in a chain manner together by the bypass path 31 is set based on the following Equation (1), when defining a natural number as N, and a ratio achieved by dividing the adsorption time of the sorbent material 12 by the desorption time as R.

M=N×(R+1) Equation (1)

By setting the number of modules 11 corresponding to the time ratio of each of adsorption/desorption of the sorbent material 12, and the operating schedule of each module 11, the operation of the adsorption process and desorption process in each module 11 becomes continuous, whereby the energy consumption can be curbed. Since the energy consumption can be suppressed, pieces of equipment having smaller output and capacity (fan 61, heat exchange device 80 and vacuum pump 62, carbon dioxide recovery pump 63) can be selected, and thus the running cost and manufacturing cost can be reduced.

Although embodiments of the present invention have been described above, it is not to be limited to the aforementioned embodiments and modified examples. In addition, the effects described in the above embodiments are merely exemplifying the preferred effects, and the effects thereof are not limited to those described in the above embodiments.

### EXPLANATION OF REFERENCE NUMERALS

1 carbon dioxide recovery device
11 module
11A first module
11B second module
12 sorbent material
30 three-way valve
31 bypass path
32 bypass valve
61 fan
62 vacuum pump
63 carbon dioxide recovery pump
80 heat exchange device
81 heat exchanger
82 cold water tank
83 hot water tank

What is claimed is:

1. A carbon dioxide recovery device comprising:
a plurality of modules, each one including a sorbent material inside thereof, and executing an adsorption process of aspirating gas containing carbon dioxide and adsorbing the carbon dioxide to the sorbent material; and a desorption process of desorbing the carbon dioxide from the sorbent material by heating in a state where a periphery of the sorbent material is reduced pressure;
a heat exchanger that supplies heat for heating the sorbent material to each of the plurality of modules via a heat transfer medium; and
a bypass path that connects a first module, which is one among the plurality of the modules, with a second module, which is different from said first module, and enables circulation of the heat transfer medium therebetween.

2. The carbon dioxide recovery device according to claim 1, wherein heat supply from the first module to the second module is performed by the heat transfer medium which conducted cooling of the first module after the desorption process being supplied through the bypass path to the second module undergoing temperature rise in the desorption process.

3. The carbon dioxide recovery device according to claim 1, further comprising a hot water tank that is disposed between the heat exchanger and the module, and stores hot water as the heat transfer medium.

4. The carbon dioxide recovery device according to claim 2, further comprising a hot water tank that is disposed between the heat exchanger and the module, and stores hot water as the heat transfer medium.

5. The carbon dioxide recovery device according to claim 3, wherein the carbon dioxide recovery device raises temperature of the sorbent material by a two-stage heating of heating the sorbent material by performing heat supply from the hot water tank to the second module, after heating the sorbent material by performing heat supply from the first module to the second module via the bypass path.

6. The carbon dioxide recovery device according to claim 4, wherein the carbon dioxide recovery device raises temperature of the sorbent material by a two-stage heating of heating the sorbent material by performing heat supply from the hot water tank to the second module, after heating the sorbent material by performing heat supply from the first module to the second module via the bypass path.

7. The carbon dioxide recovery device according to claim 5, wherein the carbon dioxide recovery device performs heat supply from the first module to the second module via the bypass path, when a temperature difference between the sorbent material in the first module undergoing cooling after the desorption process and the sorbent material in the second module which is a temperature rise target in the desorption process is a fixed value or more, and closes the bypass path and starts heat supply from the hot water tank, when the temperature difference between the sorbent material in the first module undergoing the cooling and the sorbent material in the second module which is the temperature rise target is less than a fixed value.

8. The carbon dioxide recovery device according to claim 6, wherein the carbon dioxide recovery device performs heat supply from the first module to the second module via the bypass path, when a temperature difference between the sorbent material in the first module undergoing cooling after the desorption process and the sorbent material in the second module which is a temperature rise target in the desorption process is a fixed value or more, and closes the bypass path and starts heat supply from the hot water tank, when the temperature difference between the sorbent material in the first module undergoing the cooling and the sorbent material in the second module which is the temperature rise target is less than a fixed value.

9. The carbon dioxide recovery device according to claim 1, further comprising:
a fan that supplies gas to inside of the module;
a heat source that performs heat supply for heating the sorbent material in the module; and
a vacuum pump that aspires gas inside of the module, wherein at least one among the fan, the heat source and the vacuum pump is shared between the plurality of the modules, and a number M of the modules that are connected in a chain manner together by the bypass path is set based on Equation (1) below, when defining a natural number as N and a ratio obtained by dividing an adsorption time of the sorbent material by a desorption time as R:
$$M = N \times ( R + 1 ) . \qquad Equation ( 1 )$$

10. The carbon dioxide recovery device according to claim 2, further comprising:
a fan that supplies gas to inside of the module;
a heat source that performs heat supply for heating the sorbent material in the module; and
a vacuum pump that aspires gas inside of the module, wherein at least one among the fan, the heat source and the vacuum pump is shared between the plurality of the modules, and a number M of the modules that are connected in a chain manner together by the bypass path is set based on Equation (1) below, when defining a natural number as N and a ratio obtained by dividing an adsorption time of the sorbent material by a desorption time as R:
$$M = N \times ( R + 1 ) . \qquad Equation ( 1 )$$
